(19) United States
(12) Patent Application Publication
(10) Pub. No.: US 2021/0035090 A1
(43) Pub. Date: Feb. 4, 2021

(54) SYSTEM AND METHOD FOR SECURE DATA DELIVERY

(71) Applicant: Philip Michael IANNACCONE, Santa Monica, CA (US)

(72) Inventor: Philip Michael IANNACCONE, Santa Monica, CA (US)

(21) Appl. No.: 16/964,544

(22) PCT Filed: Jan. 23, 2019
(86) PCT No.: PCT/US2019/014841

§ 371 Date: Jul. 23, 2020

Related U.S. Application Data
(60) Provisional application No. 62/620,625, filed on Jan. 23, 2018.

(51) Int. Cl. G06Q 20/36; H04L 9/06; H04L 9/08

(52) U.S. Cl. CPC G06Q 20/3672; G06Q 20/3674; H04L 2209/38; H04L 9/0825; H04L 9/0618

(57) ABSTRACT

A system for data rights management and data distribution using deliberately constrained message integrity. When linked with a public distributed ledger technology (DLT) (e.g., a blockchain, a directed acyclic graph (DAG)), a system in accordance with this disclosure discourages redistribution of raw data in a decentralized manner without the need for policing or identification-based reputation building making it suitable for anonymous or single use data purchases.

### CROSS-REFERENCE TO RELATED APPLICATIONS

This application claims the benefit of U.S. Provisional Patent Application No. 62/620,625, filed Jan. 23, 2018, the contents of which are incorporated herein by reference in its entirety for all purposes.

### FIELD OF THE DISCLOSURE

This relates generally to secure data delivery.

### BACKGROUND OF THE DISCLOSURE

Current digital rights management systems, content broadcasting networks, and software distribution platforms suffer from the high overhead of enforcing license agreements and prosecuting violators for improper redistribution. This overhead comes at the expense of the data distributor (e.g., the media's originator) and can make the creative venture of producing works unproductive. The nature of transforming works of authorship into a digital medium for convenient sale and consumption also makes them easy for copying and redistribution (e.g., counterfeiting). A system in accordance with this disclosure addresses this problem with a system for delivering the digital works in a form that hinders unwanted redistribution.

### SUMMARY OF THE DISCLOSURE

Examples of the disclosure are directed to a computer system that interfaces with distributed ledger technology (DLT) (e.g., blockchains, directed acyclic graphs (DAGs)) for secure data delivery. In some examples, the computer system uses a public key associated with a distributed ledger wallet to encrypt data (e.g., messages, media content, or any other digital file or data stream). Using a public key associated with a distributed ledger wallet to encrypt data provides a measure of control over unwanted (e.g., unauthorized) redistribution and eliminates the need for a key exchange between the computer system and a requester (e.g., a server, laptop, desktop computer, tablet, smartphone, and/or any other device) of the data. Moreover, encrypting the requested data with the public key associated with a distributed ledger wallet ensures that only the requester controlling that distributed ledger wallet can access the requested data—even when the encrypted data is added to the distributed ledger. In some examples, the computer system retrieves public key addresses, corresponding cryptocurrency, or smart contract token holding amounts on a distributed ledger, and requested telecommunications destination details such as IP address and/or port numbers in an encrypted and/or plaintext form as data are added to the distributed ledger. In some examples, at least one communication channel is established for delivering media, data, and/or any other digital content in a form that has deliberately limited message integrity. In some examples, the data is uploaded to a database, a distributed ledger, or any other destination.

### BRIEF DESCRIPTION OF THE DRAWINGS

FIG. 1 illustrates a network including various devices according to examples of the disclosure.

FIG. 2 illustrates a block diagram of a multifunction device according to examples of the disclosure.

FIG. 3 illustrates how various devices can interact according to examples of the disclosure.

FIG. 4 illustrates a cryptographic flow diagram according to examples of the disclosure.

FIG. 5A illustrates a process for delivering data according to examples of the disclosure.

FIG. 5B illustrates a process for acquiring data according to examples of the disclosure.

FIG. 6A illustrates a process for delivering data according to examples of the disclosure.

FIG. 6B illustrates a process for acquiring data according to examples of the disclosure.

### DETAILED DESCRIPTION

In the following description of examples, references are made to the accompanying drawings that form a part hereof, and in which it is shown by way of illustration specific examples that can be practiced. It is to be understood that other examples can be used and structural changes can be made without departing from the scope of the disclosed examples. Further, in the context of this disclosure, data “integrity” (or the like) can refer to delivery of the data from the requested source (e.g., assurance that the data or message was received as intended from the requested source without redactions or edits).

Examples of the disclosure are directed to a computer system that interfaces with distributed ledger technology (DLT) (e.g., blockchains, directed acyclic graphs (DAGs)) for secure data delivery. In some examples, the computer system uses a public key associated with a distributed ledger wallet to encrypt data (e.g., messages, media content, or any other digital file or data stream). Using a public key associated with a distributed ledger wallet to encrypt data provides a measure of control over unwanted (e.g., unauthorized) redistribution and eliminates the need for a key exchange between the computer system and a requester (e.g., a server, laptop, desktop computer, tablet, smartphone, and/or any other device) of the data. Moreover, encrypting the requested data with the public key associated with a distributed ledger wallet ensures that only the requester controlling that distributed ledger wallet can access the requested data—even when the encrypted data is added to the distributed ledger. In some examples, the computer system retrieves public key addresses, corresponding cryptocurrency, or smart contract token holding amounts on a distributed ledger, and requested telecommunications destination details such as IP address and/or port numbers in an encrypted and/or plaintext form as data is added to the distributed ledger. In some examples, at least one communication channel is established for delivering media, data, and/or any other digital content in a form that has deliberately limited message integrity. In some examples, the data is uploaded to a database, a distributed ledger, or any other destination.

For the purpose of this disclosure the concept of a subscription or one-time sale comprises two aspects: the raw information (e.g., data) received and the integrity of the delivery (e.g., indicating that the data is received from a trusted source). Without integrity of delivery from the authoritative source (e.g., the source of the data, the content creator, authorized distributor), the information received is of lower value because the provenance cannot be determined and the information can possibly be counterfeit. It may still be impossible to inherently constrain the raw information disclosed to the recipient along with any derivative works drawn from inspiration or conclusions from that delivery (e.g., restrict edited redistributions) without the use of courts and enforcement threats. However, the system in accordance with this disclosure provides a way to have deliberately constrained distribution of the content delivery (e.g., restrict pure redistribution), thus allowing for one-time certification of underlying data. Once the chain of provable veracity is broken (e.g., when unauthorized redistribution occurs) any further redistribution or disclosure is reduced to recollections from entities unrelated to the raw data (e.g., not the content creator, authorized distributor) and subject to their own reputation and identity discounting. Importantly, this constrained integrity is achieved passively by the invention through novel system architecture by aligning incentives, not as is currently done through policing or post-violation enforcements.

Other schemes exist where communities have been able to incentivize proper behavior at some later time by storing value in escrow until future promises have been kept. For example, in the familiar case of bottle deposits, a promise to return an empty bottle for recycling is secured by collection of a nominal (e.g., a nickel) surcharge to the item's cost and returning that surcharge once the bottle is returned. These procedures however do not translate well to digitized creative works or collected digital data. Copying digital data is nearly costless when compared to replicating a physical bottle. In fact, the grocery store's deposit amount ought to be capped at the lowest production cost of a new bottle or risk being gamed by an influx of new bottles. This unfortunately prevents the community from placing a higher value on desired future actions. Furthermore, in the bottle example, a trust relationship is required with the store as the deposit holder. It is advantageous to have an unbounded collateral value and for it to be stored in a trustless manner This disclosure provides these features in a way applicable to digitized information.

In a system in accordance with this disclosure, a secret is provided by the digital media requester (or subscriber) as collateral. The requester (or subscriber) must be sufficiently motivated to preserve this secret as private information to prevent the temptation of redistributing the purchased content. If the media requester is subject to a high enough financial loss once this secret is revealed, both the content owner and content licensee have aligned incentives to prevent further disclosure or redistribution, as described in further detail below.

A useful form of collateral for the described system can be DLT tokens (e.g., cryptocurrency). For example, bitcoin, a type of cryptocurrency, was introduced in a 2008 article by Satoshi Nakamoto in a paper entitled “Bitcoin: A Peer-to-Peer Electronic Cash System,” the entire contents of which are hereby incorporated by reference for all purposes. Bitcoin and other cryptocurrencies derive their value from the operation of a distributed ledger. A blockchain is a data structure that stores a list of transactions and can be thought of as a decentralized (e.g., distributed) electronic ledger system that stores data (e.g., records transactions between a sending identifier and receiving identifier). The data (e.g., transactions) are periodically packaged into blocks and every block following the genesis block refers back to or is linked to a prior block in the chain. Computer nodes, which may operate in a peer-to-peer fashion, without trust or central authority, can maintain the blockchain (e.g., store a copy or portion of the blockchain) and cryptographically validate each new block (and by virtue all of the transactions contained in that corresponding block). This validation process can include solving a computationally difficult problem that is also easy to verify and is generally referred to as a “proof-of-work.” Other validation schemes involve a “proof-of-stake” scheme or a hybrid between proof-of-work and proof-of-stake. In a proof-of-stake scheme, large holders are incentivized to only validate appropriate transactions as doing otherwise harms the expected future network value and by extension their proven asset holdings. Examples of popular blockchain platforms in operation include Bitcoin and Ethereum. In a DAG, there is no single thread to the chain. Newer data still references older data but in many different possible links, so long as the linked paths result in no cycles (e.g., no loops). A DAG can comprise a distributed computer system including multiple computing network nodes that can each be configured to operate in a peer-to-peer fashion to validate and store a copy (or portion) of the distributed ledger. Distributed ledger (e.g., blockchain, DAG) data can include one or more wallets (e.g., one or more wallets can be maintained on a distributed ledger), each wallet being associated with, but not limited to, a blockchain address, a public key, a private (e.g., secret) key, and tokens (e.g., cryptocurrency). In some examples, each transaction (e.g., a transfer of one or more tokens from a first wallet to a second wallet) is encrypted (e.g., digitally signed) with the private key and decrypted with the public key (e.g., through asymmetric encryption algorithms) to ensure that the transaction was initiated by the owner of the first wallet.

Ethereum further generalized blockchain ledgers to encode business logic and allow persistent storage of any consensus-critical state in a blockchain virtual machine (e.g., the Ethereum Virtual Machine or “EVM”). This blockchain virtual machine was described in an article by Vitalik Buterin, entitled “Ethereum White Paper: A Next Generation Smart Contract and Decentralized Application Platform,” the entire contents of which are hereby incorporated by reference for all purposes. A collection of related business logic (e.g., executable functions) and its state (e.g., state variables) is often referred to as a smart contract. In some examples, smart contracts are computer programs and/or scripts that can be stored and executed on a blockchain (e.g., by one or more nodes on the blockchain). These functions can be executed by one or more nodes of a blockchain when invoked in response to a new transaction being added to the blockchain or another triggering event (e.g., a function call, a meeting of certain criteria). For example, smart contracts can track tradeable balances often referred to as tokens (e.g., implement blockchain wallets as described above). In addition, a blockchain can also store and execute (e.g., by one or more nodes on the blockchain) decentralized applications (DApps), which are applications that can use one or more smart contracts. For example, DApps can provide a graphical user interface (GUI) to smart contracts (e.g., using HyperText Markup Language (HTML), Cascading Style Sheets (CSS), JavaScript, Qt Modeling Language (QML), or other web technologies). In some examples, a DApp can be used to interact with the smart contract(s) (e.g., to provide a GUI for a user to interact with one or more smart contracts). In some examples, smart contracts and/or DApps can serve as application programing interfaces (APIs) that are responsive to Hypertext Transfer Protocol (HTTP) requests (e.g., smart contracts and/or DApps can retrieve information from a blockchain in response to a HTTP GET request, smart contracts and/or DApps can add data to a blockchain or make smart contract function calls in response to a HTTP POST request). Because tokens (e.g., cryptocurrency) can be spent or represent credit on a blockchain, they can possess value of their own and may also serve as a collateral source for a system in accordance with this disclosure, as described in further detail below.

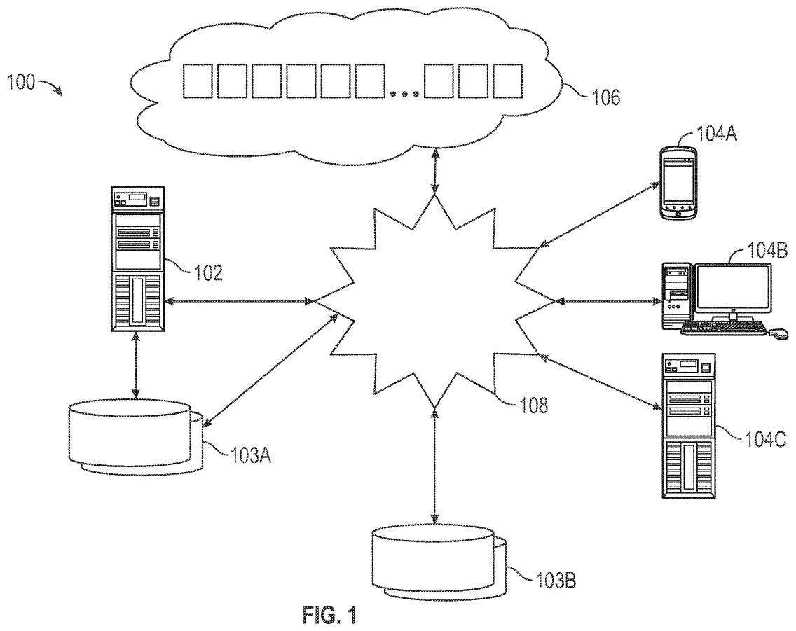

FIG. 1 illustrates a network 100 including various devices according to examples of the disclosure. As illustrated, the devices can include, for example, server 102 which can implement a digital rights management system, a content broadcasting network, software distribution platform, or host any software application (and/or mobile app) for delivering data (e.g., can perform server-end functions of the software application and/or mobile app) and/or host a website for providing similar functionality as the software application or mobile app, databases 103A which can store data (e.g., including private and public key pairs, requested data, and/or ciphertext), databases 103B which can store ciphertext, devices 104A-104C (e.g., servers, laptops, desktop computers, tablets, smartphones, and/or any other devices) for running the software application and/or mobile app supported by server 102 and/or for interacting with a website hosted on sever 102, and distributed ledger 106 (e.g., as described above). Server 102, databases 103A-103B, devices 104A-104C, and distributed ledger 106 can interact (e.g., communicate) with each other via communications network 108 (e.g., the Internet). For example, server 102 can send and receive data or messages to/from devices 104A-104C, and vice versa, through communications network 108. In some examples, sever 102 can make the software and/or mobile app for delivering data available for download (e.g., at databases 103A and/or 103B, on distributed ledger 106, at a software repository or app store). In some examples, server 102 can interact with one or more databases 103A-103B directly or via communications network 108 (e.g., the Internet). In some examples, server 102 can make requested data (e.g., in encrypted form as described below) available for download (e.g., at one or more databases 103B and/or on distributed ledger 106). For example, server 102 can upload ciphertext on one or more databases 103B for download by any of devices 104A-104C. In some examples, server 102 can access data (e.g., token information, wallet information), smart contracts, decentralized applications (DApps), etc. on distributed ledger 106 through communications network 108.

Although only one server, two databases, three devices, and one distributed ledger are shown in FIG. 1, it should be understood that additional or fewer servers, databases, devices and/or distributed ledgers can be connected to the same communications network 108. For example, server 102 can represent two or more servers (e.g., one or more servers for hosting server-end functionality of a software application, one or more servers for hosting server-end functionality of a mobile app, one or more servers for hosting the mobile app for download, a server for hosting a website for providing similar functionality as the software application or mobile app). Additionally or optionally, server 102 can also add data to distributed ledger 106, retrieve data from distributed ledger, encrypt data, decrypt data, and/or perform any other processes that may be a part of any processes described below. Server 102 can provide logic and/or content to run a particular software application or mobile app (e.g., a secure data delivery app) on devices 104A, 104B, and/or 104C (and/or other devices on the same network). In one example, devices 104A, 104B, and/or 104C can access a website hosted on server 101 via the communications network 108 (e.g., the Internet). The communications network 108 can be a secured or unsecured network. It should be understood that each distributed ledger 106 can represent a blockchain or a DAG.

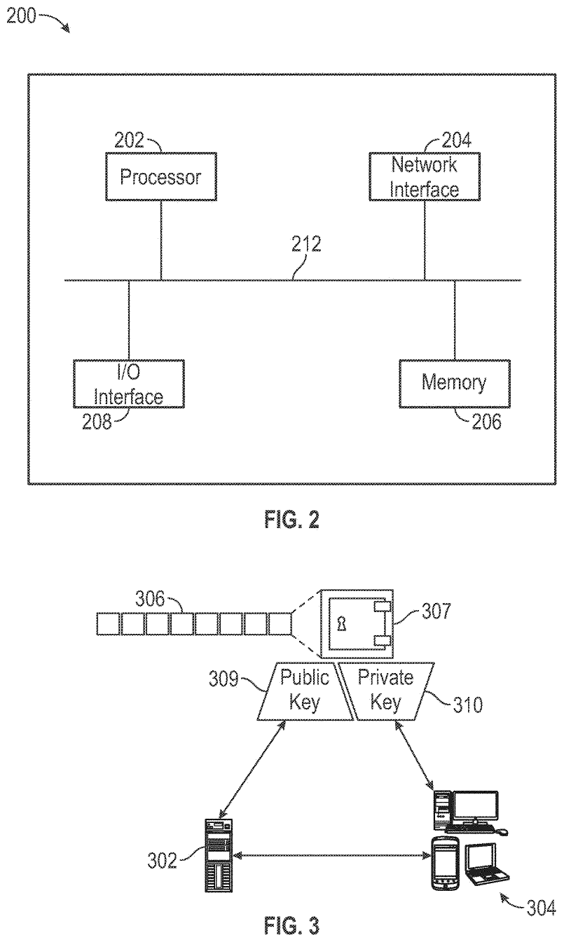

FIG. 2 illustrates a block diagram of a multifunction device 200 according to examples of the disclosure. As illustrated, device 200 can include processor 202 (e.g., a central processing unit (CPU)), network interface 204 (e.g., a transceiver), memory 206, and input/output (I/O) interface 208, all of which can be connected to each other via a system bus 212. Processor 202 can perform any of the methods described with reference to FIGS. 1 and 3-6 (including encryption and/or decryption algorithms). Additionally, network interface 204 can perform any of the networking operations (e.g., peer-to-peer file sharing, FTP) and/or communications (e.g., internet communications, encrypted messaging, email, text, phone calls) described with reference to FIGS. 1 and 3-6. Moreover, memory 206 can store data and instructions for performing any or all of the methods described with reference to FIGS. 1 and 3-6. Memory 206 can be any non-transitory computer-readable storage medium, such as a solid-state drive or a hard disk drive or a combination of both, among other examples. Further, I/O interface 208 can interact with any I/O components contained within and/or attached to device 200, including, but not limited to, one or more of a group comprising: a display, keyboard, keypad, touch screen, speaker, and microphone. In some examples, multifunction device 200 can represent a node of a distributed ledger that can store distributed ledger data, smart contracts, and/or DApps in memory 206, run smart contracts and/or DApps on processor 202, and/or perform peer-to-peer file sharing protocol operations (e.g., through Swarm) and/or messaging operations (e.g., through Whisper) through network interface 204 (e.g., as described above with reference to FIG. 1). In some examples, multifunction device 200 can represent any of the other devices shown in FIG. 1 (e.g., server 102, databases 103A-103B).

A system in accordance with the disclosure also utilizes public key cryptography, also known as asymmetrical cryptography. Asymmetric key cryptosystems, including those based on Diffie-Hellman, Rivest-Shamir-Adelman (RSA), Elliptic Curve Cryptography (ECC), or Digital Signature Algorithm (DSA) algorithms can be used in conjunction with the disclosed computer system. In some examples where nested encryptions are performed, cryptosystems with commutative and/or non-commutative properties can be utilized, including those based on non-abelian group theory such as the Anshel-Anshel-Goldfeld protocol or the Sakalauskas-Tvarijonas-Raulynaitis (STR) protocol. These cryptosystems employ three main functions: key generation “G”, encryption “E”, and decryption “D”. The function G produces a public/private (e.g., secret) key pair (“Pk” and “Sk”, respectively). The function E takes as an input the public key Pk, a message “m”, and outputs a ciphertext “c” (e.g., c=E(Pk,m)). The decryption function D can take as an input the secret key Sk and a ciphertext c and outputs the original message m (e.g., m=D(Sk,c)). With this set of functions, secured information may be exchanged publicly between two or more parties without necessarily disclosing key secrets (e.g., without exchanging private keys) or other secrets among the parties involved in the exchange. Key pairs are split between public keys which may be disseminated freely (e.g., are publicly known), and private (e.g., secret) keys in which access is restricted (e.g., to the wallet owner). The functions E and D can still be performed by swapping keys within the correlated pair, and the labels public and private are used more to reference the extent by which they are known, not which function must use them as inputs. In some examples, the public and private keys used for encryption and decryption can be the public and private keys associated with a distributed ledger wallet.

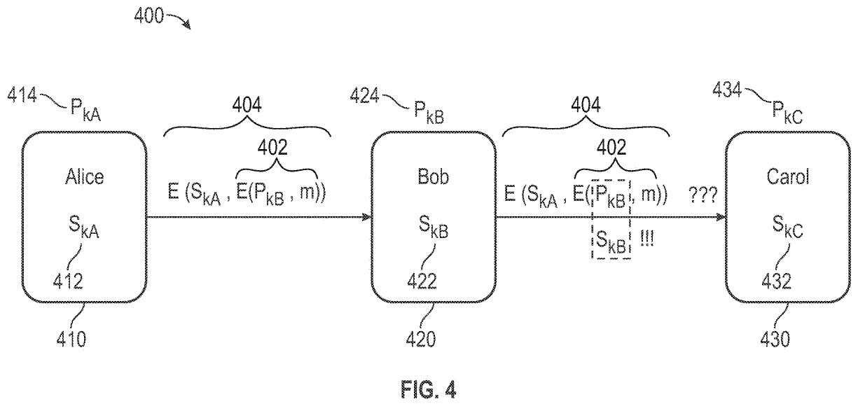

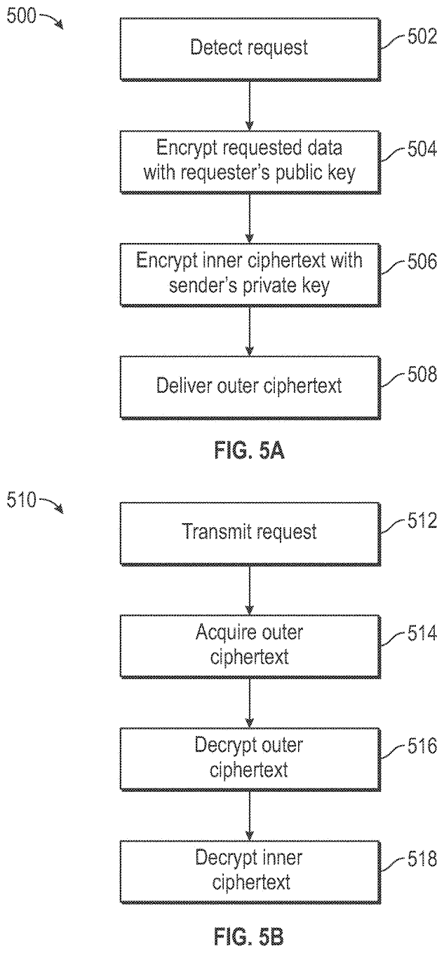

FIG. 3 illustrates how various devices can interact according to examples of the disclosure. For example, FIG. 3 shows publishing computer system 302 interacting with devices 304 and/or distributed ledger 306. In some examples, publishing computer system 302 can monitor distributed ledger 306 (e.g., monitor transactions added to the distributed ledger), obtain data from distributed ledger 306 (e.g., obtain token information, smart contract information, wallet information, public key information), and/or add data to distributed ledger 306 (e.g., add transactions to the distributed ledger). For example, the publishing computer system 302 can obtain public key 309 associated with the stored collateral data 307 (e.g., a distributed ledger wallet, a distributed ledger transaction) and use public key 309 for a first encryption of data (e.g., media content, a message) to be sent to one or more devices 304. In some examples, distributed ledger wallet 307 can correspond to a subscriber requesting data from publishing computer 302. In some examples, encrypting the requested data with the subscriber's public key 309 (e.g., a public key associated with the subscriber's wallet on the distributed ledger) for delivery ensures that the data (e.g., media content, message) can only be deciphered (e.g., decrypted) by the intended recipient (e.g., subscriber) who is also in possession of the corresponding private key 310 that also unlocks the deposited collateral (e.g., enables a user to add one or more transactions to a distributed ledger transferring one or more tokens in and/or out of the distributed ledger wallet). In this way, forwarding the encrypted content (e.g., media, data) to other devices or persons (e.g., other than the intended recipient) does no harm without also forwarding corresponding private key 310 because its encrypted form renders the content unreadable for unintended parties. If the subscriber (e.g., the receiving party) sends the private key 310 along with the encrypted content, the receiving party would also be removing the security protecting the deposited collateral information (e.g., would be providing access to the tokens in the distributed ledger wallet). This can help ensure that the subscriber does not redistribute the encrypted content because such redistributed encrypted content would be inaccessible without also distributing the subscriber's private key. In some examples, the public collateral key 309 could be a public address on the distributed ledger associated with a cryptocurrency or smart contract token found on a distributed ledger 306 (e.g., the public address of a distributed ledger wallet). In this way, the private collateral key representing ownership of the crypto-asset is the same key required to decode the delivered media. In some examples, the public address associated with a cryptocurrency or smart contract token found on a distributed ledger 306 (e.g., the public address of a distributed ledger wallet) can be derived from the public collateral key 309 (e.g., by performing a hash operation on all or part of the public collateral key). In some examples, any threshold payment and/or deposit amount of the crypto-asset collateral could be mandated to initiate (or continue) data transfer and staking of this amount by the consumer can be publicly verified on the distributed ledger 306. For example, a subscriber could be required to add one or more transactions 307 to distributed ledger 306 requesting data from publishing computer system 302 with a threshold amount of tokens (e.g., an amount sufficient to include a minimum balance and/or a fee for the requested data) to initiate the data delivery (e.g., require one or more transaction funding a collateral wallet and/or one or more transactions delivering payment to another wallet/recipient). Publishing computer system 302 can observe this transaction and initiate the data delivery process (e.g., as described below with reference to FIG. 5A). In some examples, a distributed ledger wallet 307 with a threshold amount of tokens (e.g., an amount sufficient to include a minimum balance and/or a fee for the requested data) can be required for the publishing computer system 302 to fulfill a data request. For example, publishing computer system 302 may transmit a requested data stream (e.g., media content, scientific data, financial information) only while distributed ledger wallet 307 contains the threshold amount of tokens. Should the balance of distributed ledger wallet 307 fall below the threshold amount of tokens, the publishing computer system 302 may stop transmitting the requested data. In some examples, a completed payment (e.g., a signed cryptocurrency send transaction, mined on-chain cryptocurrency transfer transaction, wire transfer, credit card authorization) for the data fee amount along with a deposit amount in wallet 307 can be required for the publishing computer system 302 to fulfill a data request. In some examples, publishing computer system 302 can correspond to server 102, distributed ledger 306 can correspond to distributed ledger 106, and devices 304 can correspond to devices 104A-104C of FIG. 1. In some examples, publishing computer system 302 can interact with devices 304 (or vice versa) directly, as shown in FIG. 4, or can interact through a network (e.g., network 108 of FIG. 1). In some examples, publishing computer system 302 or any of devices 304 can interact with distributed ledger 306 directly, as shown in FIG. 4, or can interact through a network (e.g., network 108 of FIG. 1)

As described thus far, anyone could still send fraudulent or counterfeit information or data (e.g., media, content) to a requester with this scheme because the requester's public key is knowable to all (e.g., anyone can encrypt fraudulent or counterfeit content with the requester's public key and deliver that encrypted fraudulent or counterfeit content to the requester). In some examples, data (e.g., media content, message) integrity can be achieved by performing a second encryption using the distributor's (e.g., the source of the data, the content creator, authorized distributor, or any authoritative source) secret (e.g., private) key applied to the ciphertext from the original collateralizing encryption (e.g., the data encrypted with the recipient's public key). For example, FIG. 4 illustrates a cryptographic flow diagram 400 according to examples of the disclosure. In some examples, a first device 410 corresponding to user Alice can have a private key (S_{kA}) 412 and a public key (P_{kA}) 414 associated with device 410 or user Alice (e.g., associated with a distributed ledger wallet associated with device 410 or user Alice) can send data to a second device 420 corresponding to user Bob, which can also have a private key (S_{kB}) 422 and a public key (P_{kB}) 424 associated with device 420 or user Bob (e.g., associated with a distributed ledger wallet associated with device 420 or user Bob). To send data to second device 420, first device 410 can encrypt data “m” (e.g., media content, message) with Bob's public key (P_{kB}) to create inner ciphertext 402 (e.g., the inner encryption), encrypt inner ciphertext 402 with Alice's private key (S_{kA}) 412 to create outer ciphertext 404 (e.g., the outer encryption), and send outer ciphertext 404 to second device 420. Because the outer encryption is done for authentication purposes, it can alternatively be replaced with other digital signature algorithms including: Probabilistic Signature Scheme (PSS), Digital Signature Algorithm (DSA), Elliptic Curve Digital Signature Algorithm (ECDSA), ElGamal signature scheme, Schnorr signatures, Message Authentication Code (MAC), or other similar algorithm. In some examples, the outer encryption is not commutative with respect to the inner encryption. Having wrapped the distributor's signature around the already encrypted content (e.g., to create outer ciphertext 404), the media recipient (e.g., Bob or second device 420) can now reverse the signing process using the distributor's (e.g., Alice's) public key before deciphering the requested data using their own private key. For example, second device 420 can then decrypt outer ciphertext 404 with Alice's public key (P_{kA}) 414 to obtain inner ciphertext 402 and decrypt inner ciphertext 402 with Bob's private key (S_{kB}) 422. In this way, message integrity would be broken before it would be possible to retransmit any clear text content (e.g., a second recipient, such as Carol, would not be assured that the redistributed data is not fraudulent or counterfeit as it would not be encrypted with the original sender's private key). Moreover, Bob would be disincentivized to transmit outer ciphertext 404 or inner ciphertext 402 to a third device because the third device would then need to request Bob to also transmit his private key (S_{kB}) 422 to decrypt inner ciphertext 402 to access the data “m” (e.g., media content, message).

FIG. 5A illustrates a process 500 for delivering data according to examples of the disclosure. It should be understood that process 500 can represent a process performed by a remote server (e.g., server 102 of FIG. 1) or any multifunction device (e.g., multifunction device 200 of FIG. 2). In some examples, process 500 can be used by a digital rights management system, a content broadcasting network, software distribution platform, or any other system for delivering data. It should be understood that the requested data can comprise media content (including video and/or audio such as television episodes, movies, music), software or standalone application, numerical information (e.g., statistical numerical data, scientific data, financial data), or any other form of digital information. In some examples, the data can comprise a file or a data stream.

At step 502, process 500 detects a request for data (e.g., from a server, laptop, desktop computer, tablet, smartphone, and/or any other device). In some examples, the request can include an identification of the data (e.g., data identification (ID), data name), destination information (e.g., IP address, email address, database information) or distributed ledger information (e.g., distributed ledger wallet address corresponding to the requester, public key corresponding to the wallet address of the requester). In some examples, process 500 can receive this request from an electronic device (e.g., from device 104A via communications network 108 of FIG. 1). In some examples, process 500 can monitor a distributed ledger (e.g., distributed ledger 106 of FIG. 1) for requests and detect when a new request (e.g., transaction transferring tokens and requesting data) is added to the distributed ledger.

At step 504, process 500 can retrieve the data from a server and/or database (e.g., server 102 and/or databases 103A of FIG. 1) using data information from the detected request (e.g., data ID) and encrypts the retrieved data with a public key associated with a wallet address corresponding to the requester to generate an inner ciphertext (e.g., as described above with reference to FIG. 4). In some examples, process 500 retrieves the public key information from a distributed ledger using information from the request received at step 502 (e.g., retrieves the public key from the wallet at the distributed ledger address specified in the request) prior to encrypting the requested data. In some examples, the public key is included in the request, as described above. In some examples, process 500 uses asymmetric encryption algorithms to generate the inner ciphertext (e.g., as described above with reference to FIG. 4). For example, by generating the inner ciphertext by encrypting the requested data with the public key associated with the wallet address, process 500 ensures that the inner ciphertext can only be decrypted with the private key associated with the same wallet (e.g., the requester of the data, entity depositing collateral). In some examples, step 504 is only performed in accordance with a determination that the distributed ledger wallet contains a number of tokens above a threshold (e.g., an amount sufficient to include a minimum balance and/or a fee for the requested data) and/or that payment has been made (e.g. a signed cryptocurrency send transaction, mined on-chain cryptocurrency transfer transaction, wire transfer, credit card authorization).

At step 506, process 500 can encrypt the inner ciphertext with a private key associated with process 500 or the device performing process 500 (e.g., server 102 of FIG. 1, multifunction device 200 of FIG. 2) to generate an outer ciphertext (e.g., as described above with reference to FIG. 4). In some examples, process 500 retrieves the private key from a database (e.g., databases 103A or 103B of FIG. 1). In some examples, process 500 uses asymmetric encryption algorithms to generate the outer ciphertext (e.g., as described above with reference to FIG. 4). For example, by generating the outer ciphertext by encrypting the inner ciphertext with the private key associated with process 500 or the device performing process 500, process 500 certifies that the outer ciphertext was generated by process 500 or a the device performing process 500 (e.g., server 102 of FIG. 1, multifunction device 200 of FIG. 2), maintaining integrity of the source of the data. In some examples, step 506 is only performed in accordance with a determination that the distributed ledger wallet contains a number of tokens above a threshold (e.g., an amount sufficient to include a minimum balance and/or a fee for the requested data) and/or that payment has been made (e.g. a signed cryptocurrency send transaction, mined on-chain cryptocurrency transfer transaction, wire transfer, credit card authorization).

At step 508, process 500 can deliver the outer ciphertext. In some examples, process 500 delivers (e.g., transmits) the outer ciphertext directly to the requester (e.g., using the destination information in the (or associated with) the request received at step 502). In some examples, process 500 adds the outer ciphertext to a distributed ledger (e.g., a blockchain, DAG). In some examples, process 500 can upload (e.g., deposit/publish) the outer ciphertext to a database (e.g., one or more of databases 103B of FIG. 1) for retrieval by the requester. In some examples, step 508 is only performed in accordance with a determination that the distributed ledger wallet contains a number of tokens above a threshold (e.g., an amount sufficient to include a minimum balance and/or a fee for the requested data) and/or that payment has been made (e.g. a signed cryptocurrency send transaction, mined on-chain cryptocurrency transfer transaction, wire transfer, credit card authorization). When the data comprises a data stream, process 500 may return to step 504.

FIG. 5B illustrates a process 510 for acquiring data according to examples of the disclosure. In some examples, process 510 can be invoked when a user requests data (e.g., from a server, laptop, desktop computer, tablet, smartphone, and/or any other device). It should be understood that process 510 can be implemented in a smart contract, DApp, a mobile app, a website, or any other computer program that can be run on a device (e.g., device 104A of FIG. 1, multifunction device 200 of FIG. 2), a remote server (e.g., server 102 of FIG. 1, server 104C of FIG. 1), and/or node of a distributed ledger (e.g., one or mode nodes of distributed ledger 106 of FIG. 1). It should also be understood that the data can comprise media content (including video and/or audio such as television episodes, movies, music), software or standalone application, numerical information (e.g., statistical numerical data, scientific data, financial data), or any other form of digital information. In some examples, the data can comprise a file or a data stream.

At step 512, process 510 transmits a request for data. In some examples, the request includes an identification of the data requested (e.g., data identification (ID), data name), identification of the data source, destination information (e.g., IP address, email address, database information) and/or distributed ledger information (e.g., wallet address on a distributed ledger corresponding to the requester, public key corresponding to the wallet address of the requester). In some examples, process 510 transmits the request to a digital rights management system, a content broadcasting network, software distribution platform, or any other system for delivering data. In some examples, process 510 transmits the request to a server (e.g., transmits request to server 102 via communications network 108 of FIG. 1). In some examples, process 510 transmits the request by adding the request (e.g., a transaction transferring tokens and requesting data) to a distributed ledger (e.g., distributed ledger 106 of FIG. 1).

At step 514, process 510 acquires outer ciphertext. In some examples, process 510 acquires the outer ciphertext from a data source (e.g., receives the outer ciphertext from server 102 of FIG. 1). In some examples, process 510 monitors a distributed ledger (e.g., distributed ledger 106 of FIG. 1) for data from a particular source, and detects when new data is added to the distributed ledger by the particular source. In some examples, process 510 then acquires (e.g., downloads) the outer ciphertext from the distributed ledger. In some examples, process 510 downloads outer ciphertext from a database (e.g., one or more databases 103B of FIG. 1).

At step 516, process 510 decrypts the outer ciphertext with a public key associated with the source of the outer ciphertext to obtain an inner ciphertext. In some examples, process 510 retrieves the public key information from a distributed ledger (e.g., retrieves the public key from a wallet or smart contract on the distributed ledger corresponding to the data source). In some examples, the outer ciphertext was generated with an asymmetric encryption algorithm (e.g., as described above with reference to FIGS. 2 and 5A) using a private key associated with the source. For example, when the outer ciphertext is generated with the private key associated with the data source, process 510 can decrypt the outer ciphertext with the public key associated with the data source.

At step 518, process 510 decrypts the inner ciphertext with a private key associated with a distributed ledger wallet corresponding to the requester (e.g., the user that invoked process 510) to obtain the requested data. In some examples, the inner ciphertext was generated with an asymmetric encryption algorithm (e.g., as described above with reference to FIGS. 2 and 5A) using a public key associated with the distributed ledger wallet corresponding to the requester. For example, when the inner ciphertext is generated with the public key associated with the distributed ledger wallet corresponding to the requester, process 510 can decrypt the inner ciphertext with the private key associated with the distributed ledger wallet corresponding to the requester.

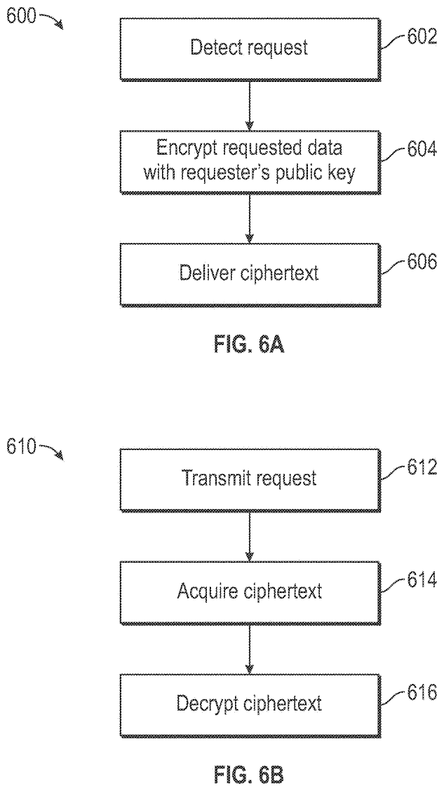

FIG. 6A illustrates a process 600 for delivering data according to examples of the disclosure. It should be understood that process 600 can represent a process performed by a remote server (e.g., server 102 of FIG. 1) or any multifunction device (e.g., multifunction device 200 if FIG. 2). In some examples, process 600 can be used by a digital rights management system, a content broadcasting network, software distribution platform, or any other system for delivering data. It should also be understood that the data can comprise media content (including video and/or audio such as television episodes, movies, music), software or standalone application, numerical information (e.g., statistical numerical data, scientific data, financial data), or any other form of digital information. In some examples, the data can comprise a file or a data stream.

At step 602, process 600 detects a request for data. In some examples, the request can include an identification of the data (e.g., data identification (ID), data name), destination information (e.g., IP address, email address, database information) or distributed ledger information (e.g., distributed ledger wallet address corresponding to the requester, public key corresponding to the wallet address of the requester). In some examples, process 600 can receive this request from an electronic device (e.g., from device 104A via communications network 108 of FIG. 1). In some examples, process 600 can monitor a distributed ledger (e.g., distributed ledger 106 of FIG. 1) for requests and detect when a new request (e.g., transaction transferring tokens and requesting data) is added to the distributed ledger.

At step 604, process 600 can retrieve the data from a server and/or database (e.g., server 102 and/or databases 103A of FIG. 1) using data information from the detected request (e.g., data ID) and encrypts the retrieved data with a public key associated with a wallet address corresponding to the requester to generate a ciphertext (e.g., as described above with reference to FIG. 4). In some examples, process 600 retrieves the public key information from a distributed ledger using information from the request received at step 602 (e.g., retrieves the public key from the wallet at the distributed ledger address specified in the request) prior to encrypting the requested data. In some examples, the public key is included in the request, as described above. In some examples, process 600 uses asymmetric encryption algorithms to generate the ciphertext (e.g., as described above with reference to FIG. 4). For example, by generating the ciphertext by encrypting the requested data with the public key associated with the wallet address, process 600 ensures that the ciphertext can only be decrypted with the private key associated with the wallet (e.g., the requester of the data). In some examples, step 604 is only performed in accordance with a determination that the distributed ledger wallet contains a number of tokens above a threshold (e.g., an amount sufficient to include a minimum balance and/or a fee for the requested data) and/or that payment has been made (e.g. a signed cryptocurrency send transaction, mined on-chain cryptocurrency transfer transaction, wire transfer, credit card authorization).

At step 606, process 600 can deliver the ciphertext. In some examples, process 600 delivers (e.g., transmits) the ciphertext directly to the requester (e.g., using the destination information in the (or associated with) the request received at step 602). In some examples, process 600 adds the ciphertext to a distributed ledger (e.g., a blockchain, DAG). In some examples, process 600 can upload (e.g., deposit/publish) the ciphertext to a database (e.g., one or more of databases 103B of FIG. 1) for retrieval by the requester. In some examples, step 606 is only performed in accordance with a determination that the distributed ledger wallet contains a number of tokens above a threshold (e.g., an amount sufficient to include a minimum balance and/or a fee for the requested data) and/or that payment has been made (e.g. a signed cryptocurrency send transaction, mined on-chain cryptocurrency transfer transaction, wire transfer, credit card authorization). When the data comprises a data stream, process 600 may return to step 604.

FIG. 6B illustrates a process 610 for acquiring data according to examples of the disclosure. In some examples, process 610 can be invoked when a user requests data. It should be understood that process 610 can be implemented in a smart contract, DApp, a mobile app, a website, or any other computer program that can be run on a device (e.g., device 104A of FIG. 1, multifunction device 200 of FIG. 2), a remote server (e.g., server 102 of FIG. 1), and/or node of a distributed ledger (e.g., one or mode nodes of distributed ledger 106 of FIG. 1). It should also be understood that the requested data can comprise media content (including video and/or audio such as television episodes, movies, music), software or standalone application, numerical information (e.g., statistical numerical data, scientific data, financial data), or any other form of digital information. In some examples, the data can comprise a file or a data stream.

At step 612, process 610 transmits a request for data. In some examples, the request includes an identification of the data requested (e.g., data identification (ID), data name), identification of the data source, destination information (e.g., IP address, email address, database information) and/or distributed ledger information (e.g., wallet address on a distributed ledger corresponding to the requester, public key corresponding to the wallet address of the requester). In some examples, process 610 transmits the request to a digital rights management system, a content broadcasting network, software distribution platform, or any other system for delivering data. In some examples, process 610 transmits the request to a server (e.g., transmits request to server 102 via communications network 108 of FIG. 1). In some examples, process 610 transmits the request by adding the request (e.g., a transaction transferring tokens and requesting data) to a distributed ledger (e.g., distributed ledger 106 of FIG. 1).

At step 614, process 610 acquires ciphertext. In some examples, process 610 acquires the ciphertext from a data source (e.g., receives the ciphertext from server 102 of FIG. 1). In some examples, process 610 monitors a distributed ledger (e.g., distributed ledger 106 of FIG. 1) for data from a particular source, and detects when new data is added to the distributed ledger by the particular source. In some examples, process 610 then acquires (e.g., downloads) the ciphertext from the distribute ledger. In some examples, process 610 downloads ciphertext from a database (e.g., one or more databases 103B of FIG. 1).

At step 616, process 610 decrypts the ciphertext with a private key associated with a distributed ledger wallet corresponding to the requester (e.g., the user that invoked process 610) to obtain the requested data. In some examples, the ciphertext was generated with an asymmetric encryption algorithm (e.g., as described above with reference to FIGS. 2 and 6A) using a public key associated with the distributed ledger wallet corresponding to the requester. For example, because the ciphertext is generated with the public key associated with the distributed ledger wallet corresponding to the requester, process 610 can decrypt the ciphertext with the private key associated with the distributed ledger wallet corresponding to the requester.

Other embodiments are envisioned where the collateral could be data provided in a cross-licensing agreement or private data collected by the publisher relating to the content subscriber. It is not necessary for the data requester or subscriber to be the entity depositing the collateral, only that the subscriber has a desire for that information to remain private.

Thus, the examples of the disclosure provide various ways of securely transmitting data. Practical applications include secure transmissions of various types of data where ensuring integrity of the delivery is desirable, significant, or critical. One example of a practical application is the secure transmission of an original creator's (e.g., filmmaker, musician, artist, writing) video content, music content, image content, or text context to requesting users with a technical mechanism that ensures that the transmitted content is an authorized version or authorized copy by the technical implementation of the disclosed cryptographic techniques. Another example of a practical application is the secure transmission of statistical numerical data (e.g., temperature data for tracking agricultural conditions) or scientific data (e.g., sensor data from in-process scientific experiments) from data sensing equipment to monitoring systems with a technical mechanism that ensures that the transmitted data accurately originated from the data sensing equipment by the technical implementation of the disclosed cryptographic techniques. Yet another example of a practical application is the secure transmission of financial data (e.g., time of financial transaction, amount of financial transaction, financial news, stock pricing, financial projections) to news subscribers with a technical mechanism that ensure that the transmitted financial data is from a trusted news source by the technical implementation of the disclosed cryptographic techniques.

Additionally, this disclosure provides improvements over or improves previous or conventional systems and methods for secure data delivery. For example, this disclosure is not directed to the mere concept of secure data delivery, but specifically employs practical cryptographic techniques such as public keys and private keys, which require implementation by actual real-life equipment (e.g., processors for performing encryption or decryption, computer-readable memory for storing keys, data transmission circuitry, data reception circuitry, etc.). As another example, this disclosure is not directed to merely secure data delivery in general, but specifically employs practical distributed ledger technology (DLT) like blockchains and directed acyclic graphs (DAGs), which require implementation by actual real-life equipment (e.g., distributed network nodes coordinating to host a distributed ledger, computer-readable storage medium for storing at least a portion of the distributed ledger).

By integrating together cryptographic techniques and DLT technology, this disclosure provides further improvements over or further improves previous or conventional systems and methods for secure data delivery. For example, previous or conventional cryptographic techniques using keys may have non-distributed storage, management, or maintenance of keys (e.g., at data transmission terminal, at data reception terminal, at central key server), but this disclosure's integration of cryptographic techniques with DLT technology results in technological advantages or benefits. For example, the disclosure's linking of cryptographic keys to DLT wallets imbues the keys with DLT reliability (e.g., many network nodes each maintaining a copy of the DLT-linked keys according to the DLT's distributed and coordinated nature) such that the persistence of the keys' existence is increased (e.g., lower susceptibility and risk for single-point failure of key storage at data transmission terminal, data reception terminal, or central key server). As another example, the disclosure's linking of cryptographic keys to DLT wallets simplifies system design can render equipment (e.g., components, circuitry, non-distributed storage) for performing various system overhead functions, such as anti-piracy countermeasures (e.g., embedding beacons or trackers into the content/data, padding deliberate nuisances into unofficial versions) and managing or maintaining keys (e.g., at data transmission terminal, at data reception terminal, at central key server), to be ancillary, unnecessary, or dispensable.

Therefore, according to the above, some examples of the disclosure are directed to a system comprising: a plurality of distributed network nodes hosting a distributed ledger, wherein each network node includes a non-transitory computer-readable storage medium storing at least a portion of the distributed ledger; an electronic device comprising one or more processors and a non-transitory computer-readable memory including first instructions, which when executed by the one or more processors, cause the one or more processors to perform: detecting a request from a requester for data; generating an inner ciphertext by encrypting the data with a public key PubKeyX associated with a first wallet corresponding to the requester on the distributed ledger; generating an outer ciphertext by encrypting the inner ciphertext with a private key PrivKeyY associated with the electronic device; and delivering the outer ciphertext. Additionally or alternatively to one or more of the examples disclosed above, in some examples, the request identifies the first wallet or the public key PubKeyX, and a private key PrivKeyX is further associated with one or more of the first wallet or the public key PubKeyX. Additionally or alternatively to one or more of the examples disclosed above, in some examples, the inner ciphertext is generated in accordance with a determination that the first wallet contains a number of tokens above a first threshold. Additionally or alternatively to one or more of the examples disclosed above, in some examples, the outer ciphertext is delivered in accordance with a determination that the first wallet contains a number of tokens above a first threshold. Additionally or alternatively to one or more of the examples disclosed above, in some examples, the first instructions further cause the one or more processors to perform: retrieving the public key PubKeyX from the first wallet on the distributed ledger. Additionally or alternatively to one or more of the examples disclosed above, in some examples, the request is received at the electronic device and comprises the public key PubKeyX and identification of the data. Additionally or alternatively to one or more of the examples disclosed above, in some examples, the request is detected as one or more transactions added to the distributed ledger by the requester and comprises the public key PubKeyX and identification of the data. Additionally or alternatively to one or more of the examples disclosed above, in some examples, delivering the outer ciphertext to the requester comprises adding the outer ciphertext to the distributed ledger or uploading the outer ciphertext to a database. Additionally or alternatively to one or more of the examples disclosed above, in some examples, the request further comprises a delivery destination, and delivering the outer ciphertext comprises transmitting the outer ciphertext to the data delivery destination. Additionally or alternatively to one or more of the examples disclosed above, in some examples, the data comprises one or more of a group comprising a message and media content. Additionally or alternatively to one or more of the examples disclosed above, in some examples, a public key PubKeyY is associated with the private key PrivKeyY, and the public key PubKeyY and the private key PrivKeyY are associated with a source of the data.

Some examples of the disclosure are directed to a non-transitory computer-readable medium of a first electronic device, the storage medium including instructions, which when executed by one or more processors of the first electronic device, cause the one or more processors to perform a method comprising: transmitting, from the first electronic device, a request for data from a second electronic device; acquiring an outer ciphertext generated with the requested data; decrypting the outer ciphertext using a public key PubKeyY to obtain an inner ciphertext; and decrypting the inner ciphertext using a private key PrivKeyX to obtain the requested data, wherein the private key PrivKeyX is associated with a first wallet on a distributed ledger hosted by a plurality of distributed network nodes, wherein each network node includes a non-transitory computer-readable memory storing at least a portion of the distributed ledger. Additionally or alternatively to one or more of the examples disclosed above, in some examples, the request identifies one or more of a group comprising the first wallet and the public key PubKeyX, and a private key PrivKeyX is further associated with one or more of the group comprising the first wallet and the public key PubKeyX. Additionally or alternatively to one or more of the examples disclosed above, in some examples, transmitting the request for the data from the second electronic device includes depositing a first threshold number of tokens into the first wallet. Additionally or alternatively to one or more of the examples disclosed above, in some examples, the request is transmitted from the first electronic device to the second electronic device. Additionally or alternatively to one or more of the examples disclosed above, in some examples, the request comprises a transaction added to the distributed ledger. Additionally or alternatively to one or more of the examples disclosed above, in some examples, acquiring the outer ciphertext comprises obtaining the outer ciphertext from the distributed ledger or from a database. Additionally or alternatively to one or more of the examples disclosed above, in some examples, acquiring the outer ciphertext comprises receiving the outer ciphertext from the second electronic device.

Some examples of the disclosure are directed to a method for generating a ciphertext comprising: encrypting data with a public key PubKeyX associated with a first wallet on a distributed ledger hosted by a plurality of distributed network nodes, wherein each network node includes a non-transitory computer-readable memory storing at least a portion of the distributed ledger. Additionally or alternatively to one or more of the examples disclosed above, in some examples, the data is encrypted in accordance with a determination that the first wallet contains a number of tokens above a first threshold.

Some examples of the disclosure are directed to a publishing computer system configured to communicate with a distributed blockchain computer system that includes multiple computing nodes, each computing node configured to store a copy, or a portion thereof, of a blockchain of the distributed blockchain computer system, the publishing computer system comprising: a transceiver configured to receive information attached to blocks as they are linked to the blockchain including public collateral key addresses, cryptocurrency or smart contract token holding amounts corresponding to each of the public collateral key addresses, and telecommunications destination details in an encrypted or plaintext form; a storage system configured to store a data structure for one or more publisher's public and private key pairs, a plurality of data requests posted on the blockchain, at least one public collateral key for each one of the plurality of data requests, and at least one data delivery destination for each of the data requests; a processing system that includes at least one hardware processor, the processing system configured to: in response to reception of the data requesting message: (a) verify sufficient collateral is staked on the blockchain in the public collateral key address; (b) encrypt the data requested using the retrieved public collateral key; (c) authenticate the encrypted data by a second encryption or digital signature using the publisher's private key. Additionally or alternatively to one or more of the examples disclosed above, in some examples, the publishing computer system is a distributed application running as a smart contract on a blockchain.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system comprising:
a plurality of distributed network nodes hosting a distributed ledger, wherein each network node includes a non-transitory computer-readable storage medium storing at least a portion of the distributed ledger;
an electronic device comprising one or more processors and a non-transitory computer-readable memory including first instructions, which when executed by the one or more processors, cause the one or more processors to perform:
detecting a request from a requester for data;
generating an inner ciphertext by encrypting the data with a public key PubKeyX associated with a first wallet corresponding to the requester on the distributed ledger;
generating an outer ciphertext by encrypting the inner ciphertext with a private key PrivKeyY associated with the electronic device; and
delivering the outer ciphertext.

2. The system of claim 1, wherein the request identifies the first wallet or the public key PubKeyX, and a private key PrivKeyX is further associated with one or more of the first wallet or the public key PubKeyX.

3. The system of claim 1, wherein the inner ciphertext is generated in accordance with a determination that the first wallet contains a number of tokens above a first threshold.

4. The system of claim 1, wherein the outer ciphertext is delivered in accordance with a determination that the first wallet contains a number of tokens above a first threshold.

5. The system of claim 1, wherein the first instructions further cause the one or more processors to perform:
retrieving the public key PubKeyX from the first wallet on the distributed ledger.

6. The system of claim 1, wherein the request is received at the electronic device and comprises the public key PubKeyX and identification of the data.

7. The system of claim 1, wherein the request is detected as one or more transactions added to the distributed ledger by the requester and comprises the public key PubKeyX and identification of the data.

8. The system of claim 1, wherein delivering the outer ciphertext to the requester comprises adding the outer ciphertext to the distributed ledger or uploading the outer ciphertext to a database.

9. The system of claim 1, wherein:
the request further comprises a delivery destination, and
delivering the outer ciphertext comprises transmitting the outer ciphertext to the data delivery destination.

10. The system of claim 1, wherein the data comprises one or more of a group comprising a message and media content.

11. The system of claim 1, wherein a public key PubKeyY is associated with the private key PrivKeyY, and the public key PubKeyY and the private key PrivKeyY are associated with a source of the data.

12. A non-transitory computer-readable medium of a first electronic device, the storage medium including instructions, which when executed by one or more processors of the first electronic device, cause the one or more processors to perform a method comprising:
transmitting, from the first electronic device, a request for data from a second electronic device;
acquiring an outer ciphertext generated with the requested data;
decrypting the outer ciphertext using a public key PubKeyY to obtain an inner ciphertext; and
decrypting the inner ciphertext using a private key PrivKeyX to obtain the requested data, wherein the private key PrivKeyX is associated with a first wallet on a distributed ledger hosted by a plurality of distributed network nodes, wherein each network node includes a non-transitory computer-readable memory storing at least a portion of the distributed ledger.

13. The non-transitory computer-readable medium of claim 12, wherein the request identifies one or more of a group comprising the first wallet and the public key PubKeyX, and a private key PrivKeyX is further associated with one or more of the group comprising the first wallet and the public key PubKeyX.

14. The non-transitory computer-readable medium of claim 12, wherein transmitting the request for the data from the second electronic device includes depositing a first threshold number of tokens into the first wallet.

15. The non-transitory computer-readable medium of claim 12 wherein the request is transmitted from the first electronic device to the second electronic device.

16. The non-transitory computer-readable medium of claim 12, wherein the request comprises a transaction added to the distributed ledger.

17. The non-transitory computer-readable medium of claim 12, wherein acquiring the outer ciphertext comprises obtaining the outer ciphertext from the distributed ledger or from a database.

18. The non-transitory computer-readable medium of claim 12, wherein acquiring the outer ciphertext comprises receiving the outer ciphertext from the second electronic device.

19. A method for generating a ciphertext comprising:
encrypting data with a public key PubKeyX associated with a first wallet on a distributed ledger hosted by a plurality of distributed network nodes, wherein each network node includes a non-transitory computer-readable memory storing at least a portion of the distributed ledger.

20. The method of claim 19, wherein the data is encrypted in accordance with a determination that the first wallet contains a number of tokens above a first threshold.
